(19) United States
(12) Patent Application Publication
(10) Pub. No.: US 2005/0186970 A1
(43) Pub. Date: Aug. 25, 2005

(54) Method of PoC instant temporary group chat based on presence and location

(76) Inventors: Charles Randall Yates, Fuquay-Varina, NC (US); Javor Kolev, Cary, NC (US)

Correspondence Address: COATS & BENNETT, PLLC, P O BOX 5, RALEIGH, NC, 27602, US

(21) Appl. No.: 10/783,586

(22) Filed: Feb. 20, 2004

(51) Int. Cl. H04Q 7/20

(52) U.S. Cl. 455/456.5

(57) ABSTRACT

A push-to-talk controller in a wireless network, comprising a presence server and a push-to-talk server, establishes a local ad hoc group session between an inviting mobile terminal and local mobile terminals responsive to a push-to-talk request from the inviting mobile terminal. The presence server identifies local mobile terminals within a local area of the inviting mobile terminal. The push-to-talk server then establishes the group session between the inviting mobile terminal and one or more local mobile terminals in the local area. In exemplary embodiments, the push-to-talk server sends an invite message to each of the local mobile terminals identified by the presence server and establishes the local ad hoc group session between the inviting mobile terminal and one or more of the local mobile terminals that respond to the invite message.

### BACKGROUND OF THE INVENTION

The present invention relates to push-to-talk (PTT) communications between mobile terminals, and more particularly to PTT communications with local mobile terminals in a local area of an inviting mobile terminal.

PTT communication between groups of mobile terminals, such as cellular telephones, personal data assistants, etc., is becoming increasingly popular with wireless communication customers. Currently, these capabilities support two different types of group sessions: instant group sessions and chat group sessions.

An instant group session enables a user of an inviting mobile terminal to establish a group session with a predefined group of mobile terminals. For example, a user may populate one or more user groups in advance by selecting and storing a list of mobile terminals for each user group in the memory of a PTT controller in a wireless network. Each predefined user group has an associated group ID. To establish the instant group session, the inviting mobile terminal selects one of the predefined user groups and requests that the PTT controller establish the group session with the selected user group. In response, the PTT controller retrieves the selected user group from memory using the associated group ID, evaluates any access requirements, and sends an invite message to each mobile terminal identified by the selected user group that satisfies any access requirements. The PTT controller then establishes the group session between the inviting mobile terminal and any invited mobile terminals that accept the invitation.

The instant group session also enables a user of an inviting mobile terminal to establish a group chat with an ad hoc group of manually selected mobile terminals. The inviting mobile terminal provides the ad hoc group to the PTT controller and requests that the PTT controller establish a group session with the selected mobile terminals. In response, the PTT controller sends an invite message to each mobile terminal identified in the ad hoc request that satisfies any access requirements. The PTT controller then establishes the group session between the inviting mobile terminal and any invited mobile terminals that accept the invitation.

Alternatively, a chat group session enables a user of an inviting mobile terminal to participate in a group chat that focuses on a particular subject of interest. In this type of group session, the PTT controller does not send invite messages. Instead, the PTT controller establishes a group session based on the subject of interest so that other mobile terminals may join and leave the group session at will. The structure of such group chats may be based on open or closed groups. When the established group session involves an open group, any mobile terminal with PTT capabilities may join the group session. When the established group session involves a closed group, only mobile terminals associated with the closed group may join the group session.

In all instances, conventional PTT systems establish group sessions based on defined groups of other POC users known to the inviting user and/or defined topics of interest. However, current PTT systems do not have the capability to establish group sessions based on the geographical location of mobile terminals relative to the location of an inviting mobile terminal.

### SUMMARY OF THE INVENTION

The present invention comprises a method and apparatus that establishes a local ad hoc group session between an inviting mobile terminal and local mobile terminals in the proximity of the inviting mobile terminal. According to an exemplary embodiment, the inviting mobile terminal activates a push-to-talk (PTT) input to initiate a local ad hoc group session between the inviting mobile terminal and one or more local mobile terminals within a local area of the inviting mobile terminal. The inviting mobile terminal then sends a request to a network PTT controller to establish the local ad hoc group session. The PTT controller comprises a presence server and a PTT server. The presence server identifies local mobile terminals within a local area of the inviting mobile terminal. In response to receiving the PTT request from the inviting mobile terminal, the PTT server establishes the group session between the inviting mobile terminal and one or more local mobile terminals within the local area.

In exemplary embodiments of the present invention, the PTT server establishes the local ad hoc group session by sending an invite message to local mobile terminals identified by the presence server. The local ad hoc group session is established between the inviting mobile terminal and one or more local mobile terminals that accept to the invite message.

Some embodiments of the PTT controller also include a core server and/or a group server. The group server filters the list of local mobile terminals, identified by the presence server, to identify preferred local mobile terminals, e.g. based on access options. The core server receives the request from the inviting mobile terminal and forwards a list of the local mobile terminals identified by the presence server to the PTT server.

### BRIEF DESCRIPTION OF THE DRAWINGS

FIG. 1 illustrates an exemplary wireless network according to the present invention.

FIG. 2 illustrates an exemplary mobile terminal according to the present invention.

FIG. 3 illustrates exemplary push-to-talk display menus for the mobile terminal of FIG. 2.

FIG. 4 illustrates an exemplary push-to-talk controller according to the present invention.

FIG. 5A illustrates a top-level call-flow diagram for establishing an instant group session according to conventional push-to-talk systems.

FIG. 5B illustrates a top-level call-flow diagram for establishing a chat group session according to conventional push-to-talk systems.

FIG. 6A illustrates a top-level call-flow diagram for establishing a local ad hoc group session according to the present invention.

FIG. 6B illustrates an exemplary call-flow diagram for the push-to-talk controller of FIG. 6A.

### DETAILED DESCRIPTION OF THE INVENTION

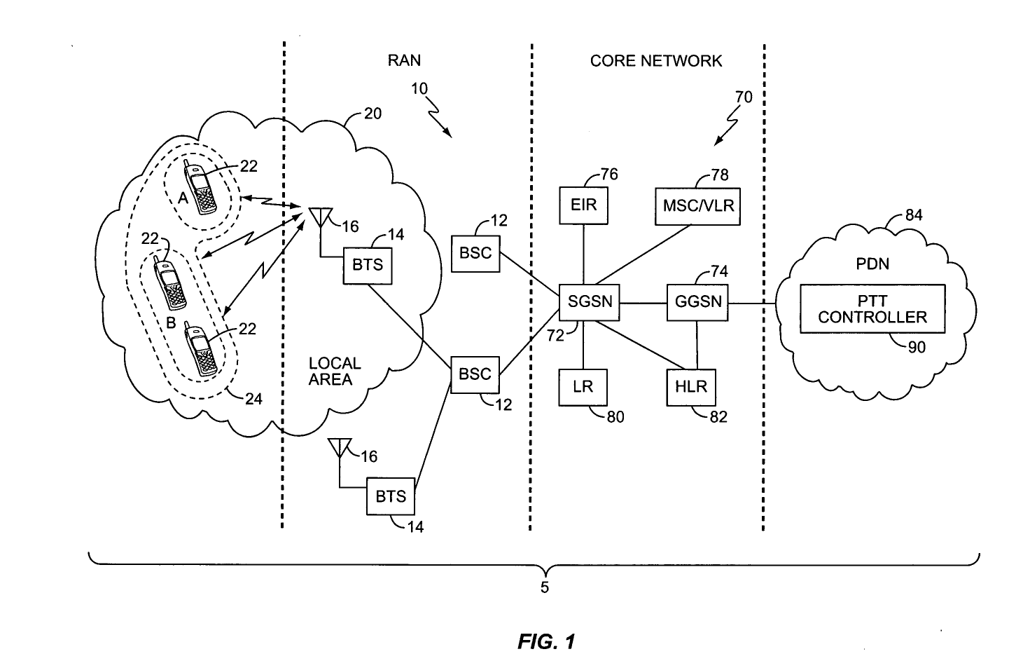

FIG. 1 illustrates a wireless communication network 5 according to the present invention. The wireless network 5 may implement any one of a variety of communication standards, including without limitation, the standards known as the Global System for Mobile Communications (GSM), General Packet Radio Service (GPRS), Universal Mobile Telecommunication System (UMTS), TIA/EIA-136, cdmaOne (IS-95B), cdma2000, and Wideband CDMA (W-CDMA). New standards are likely to evolve in the future and the enumeration of particular standards herein is not intended to be limiting. The invention will be described below in the context of a GPRS network. Those skilled in the art will appreciate that different standards may use a different network architecture or use different terminology to describe functionally equivalent elements.

The wireless communication network 5 includes a Radio Access Network (RAN) 10, a core network 70, a Packet Data Network (PDN) 84, and a plurality of mobile terminals 22. The core network 70 includes a Serving GPRS Support Node (SGSN) 72, a Gateway GPRS Support Node (GGSN) 74, an Equipment Identity Register (EIR) 76, a Mobile Switching CenterNisitor Location Register (MSC/VLR) 78, a Location Register (LR) 80, and a Home Location Register (HLR) 82. SGSN 72 routes packet data traffic between the RAN 10 and the PDN 84 via GGSN 74, where the GGSN 74 is the gateway between the core network 70 and external PDNs 84. EIR 76 registers equipment data regarding the mobile terminals 22 currently in the network 5, and typically is used for security purposes. MSC/VLR 78 allows efficient coordination between the SGSN 72 of the GPRS system and the MSC of the GSM system. HLR 82 stores a user profile, a packet data protocol address, an SGSN address, and the current location of each mobile terminal whose home network is the current core network 70. LR 80 stores the user profile and the current location of each mobile terminal 22 whose home network is a core network different from the current core network 22. Additional details regarding the operation of a GPRS network are not pertinent to the present invention, and therefore, are not discussed further herein. However, the interested reader may read “GSM Phase 2+General Packet Radio Service GPRS: Architecture, Protocols, and Air Interface,” published in IEEE Communications Surveys, Third Quarter 1999, Vol. 2 No. 3 for further details.

The core network 70 communicates with one or more mobile terminals 22 via RAN 10. RAN 10 includes one or more base station controllers (BSC) 12 that communicate with one or more base transceiver stations (BTS) 14. Each BSC 12 is responsible for managing the BTSs 14 that communicate with BSC 12. Each BTS 14 communicates with each mobile terminal 22 located within the geographic cell of the BTS 14 via BTS antenna 16.

Mobile terminals 22 communicate with PTT controller 90 within PDN 84 via BTS 14, BSC 12, SGSN 72, and GGSN 74. As discussed further below, PTT controller 90 within PDN 84 establishes a group session between two or more mobile terminals 22 based on PTT options selected by the user of an inviting mobile terminal 22. It will be appreciated that any of the mobile terminals 22 shown in FIG. 1, as well as any mobile terminal that communicates with other BSs 26 (not shown), may operate as an inviting mobile terminal 22.

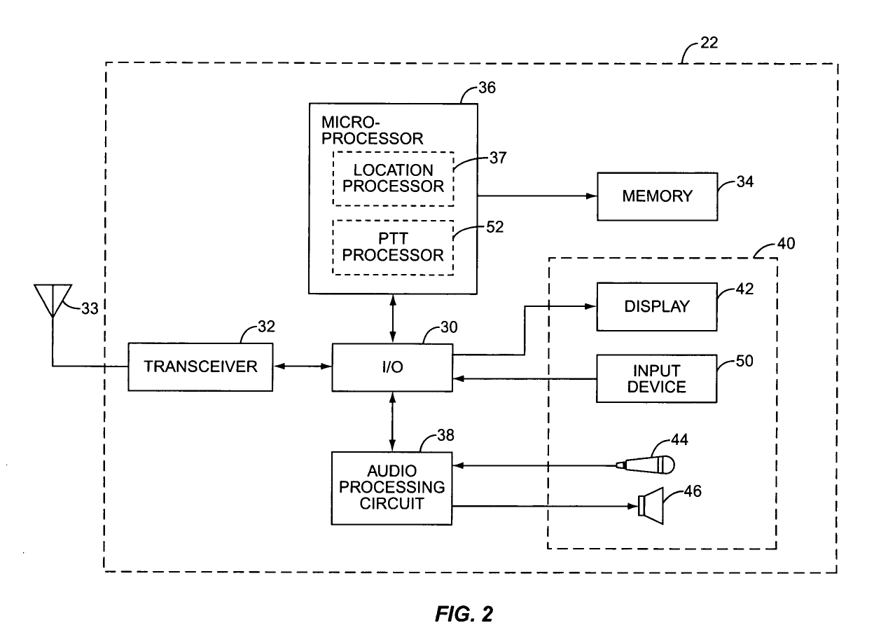

FIG. 2 shows an exemplary mobile terminal 22 with PTT capabilities according to the present invention. Mobile terminal 22 includes input/output circuit 30, transceiver 32, memory 34, microprocessor 36, audio processing circuit 38, and user interface 40. Input/output circuit 30 interfaces the transceiver 32, memory 34, microprocessor 36, audio processing circuit 38, and user interface 40 according to known interface protocols.

Transceiver 32 is a fully functional cellular radio transceiver for transmitting signals to and receiving signals from BTS 14. Those skilled in the art will appreciate that transceiver 32 may operate according to any known standard, as discussed above. Memory 34 represents the entire hierarchy of memory in a mobile terminal 22, and may include both random access memory (RAM) and read-only memory (ROM). Data and computer program instructions required for operation are stored in non-volatile memory, such as EPROM, EEPROM, and/or flash memory, which may be implemented as discrete devices, stacked devices, or integrated with microprocessor 36.

Microprocessor 36 controls the operation of mobile terminal 22 according to the programs stored in memory 34, and further may control the operation of a location processor 37 incorporated with microprocessor 36. Location processor 37 may determine the location of mobile terminal 22 and may comprise any known position locating system, such as a Global Positioning System (GPS). Further, the location processor 37 may define a local area 20 relative to the location of mobile terminal 22. More than one local area 20 may be defined for the inviting mobile terminal 22, and the defined local area may be based on a standard local area definition stored in memory 34 or based on user input. As used herein, the term “local area” describes any geographic region surrounding an inviting mobile terminal 22 by a defined distance. For example, a local area 20 may be defined as all or some portion of a BTS cell currently servicing the inviting mobile terminal 22 (as shown in FIG. 1). A local area 20 may also include portions of several adjacent BTS cells. Further, the local area 20 may be defined as a circle centered on the inviting mobile terminal 22 with a defined radius.

Microprocessor 36 may also include a PTT processor 52 that initiates a PTT session according to user specified options, as discussed further below. While location processor 37 and PTT processor 52 are shown as part of microprocessor 36, it will be understood that location processor 37 and/or PTT processor 52 may be separate components within mobile terminal 22. In any event, microprocessor 36 may comprise a single microprocessor or multiple microprocessors. Suitable microprocessors may include, for example, both general purpose and special purpose microprocessors and digital signal processors.

User interface 40 enables a user to exchange information with the mobile terminal 22, and includes a display 42, a microphone 44, a speaker 46, and an input device 50. Display 42, such as a liquid crystal display, allows operators to see dialed digits, images, call status, menu options, and other service information. Microphone 44 converts speech into electrical audio signals for processing by audio processing circuit 38. Speaker 46 converts audio signals provided by audio processing circuit 38 into audible sounds that are projected from mobile terminal 22. Input device 50 enables the user to enter data, to enter commands, and to select options, and may comprise a keypad 54, a touchpad, joystick 56, pointing device, switches, pushbuttons 58, or any other form of computer input device. The mobile terminal 22 may use two or more input devices to perform the same or different functions.

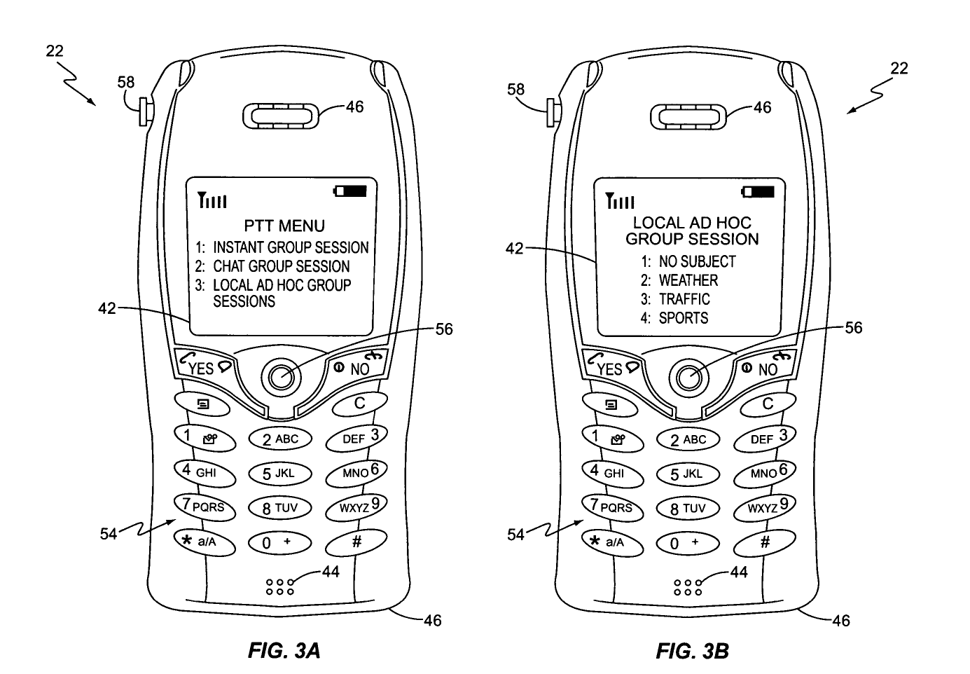

FIGS. 3A and 3B illustrate an exemplary embodiment of a mobile terminal 22 having an alphanumeric keypad 54 and, optionally, a navigation control, such as a joystick control 56, and a multi-directional/multi-functional control button 58. The PTT processor 52 (FIG. 2) of the mobile terminal 22 initiates a group session in response to user input, and may be accessed via menus displayed to the user on display 42. Keypad 54 or joystick control 56 may be used to navigate through the menus to select the desired PTT options. As shown in FIG. 3A, the PTT menu may include a number of PTT options, such as an instant group session option, a chat group session option, and a local ad hoc group session option. Further, one or more PTT menu items may include one or more sub-menus of options that may be displayed on display 42, as shown in FIG. 3B. To request a group session, the user activates the PTT processor 52 by selecting the desired PTT option or options from the displayed menu(s) using input device 50. For example, the user may navigate through the menus to reach the PTT menu (FIG. 3A). After selecting the local ad hoc group session option, one or more local ad hoc group sub-menus may be displayed on display 42 (FIG. 3B). An exemplary sub-menu may include topic of interest options, such as shown in FIG. 3B. Another exemplary sub-menu may enable the user to define the extent of the local area. The extent of the local area may be displayed in terms of distance, such as “5-mile radius,” “10-mile radius,” etc. Alternatively, the extent of the local area may be defined in terms of geography, such as “Local Cell,” “Local City,” etc. Those skilled in the art will appreciate that the sub-menus may be arranged so that the user can specify multiple options from multiple sub-menus. For example, the user may specify a “Traffic” option and a “5-mile radius” option to set up a local ad hoc group for obtaining traffic information within a 5-mile radius. In any event, the user selects the local ad hoc group session from the PTT menu to initiate the desired local ad hoc group session and, optionally, further specifies the local ad hoc group session using one or more sub-menu options.

Some embodiments of the present invention may also include voice activation capabilities that enable a user to select and activate features of the mobile terminals 22 with voice commands. In these embodiments, the user may access the PTT processor and initiates a group session by issuing one or more voice commands into microphone 44. It will be understood that other means for accessing the PTT processor 52, such as separate control buttons on housing 46, may also be used. For example, housing 46 may include a multi-directional control button 58, or optionally, a dedicated control button (not shown), that the user manipulates to select desired PTT option(s).

In any event, after the user selects the desired PTT option(s), the associated mobile terminal 22 becomes an inviting mobile terminal and sends a request to the PTT controller 90 to establish the selected group session. The mobile terminal 22 may communicate with PTT controller 90 using Session Initiation Protocol (SIP), defined in IETF RFC 3050, 3264, 3265, 3311, etc., by The Internet Engineering Task Force. Alternatively, the mobile terminal 22 may communicate with PTT controller 90 using some other industry standard protocol, such as defined in the PTT over Cellular (PoC) Standard by the Open Mobile Association standardization group, for example. PTT controller 90 establishes the group session for the inviting mobile terminal 22 based on the selected PTT option, as discussed further below. Once the group session is established, the user may, for example, control the communications with the group with multi-directional control button 58 by pressing and releasing multi-directional control button 58 to send and receive PTT communications, respectively.

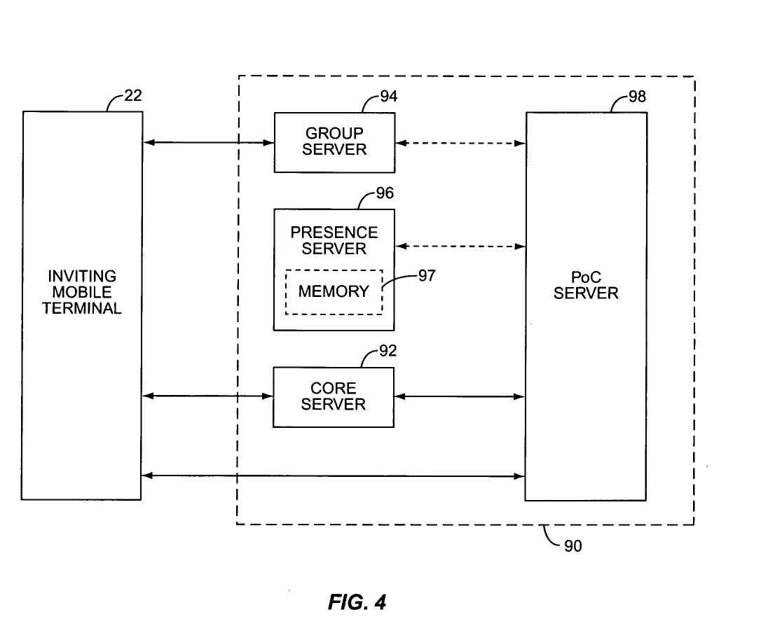

FIG. 4 illustrates an exemplary PTT controller 90 according to the present invention. PTT controller 90 includes a core server 92, a group server 94, a presence server 96, and a PTT over cellular (PoC) server 98, also referred to herein as a PTT server. Core server 92 is a Internet Protocol (IP) Multimedia Subsystem (IMS) server that is responsible for, among other things, routing the Session Initiation Protocol (SIP) signaling between the mobile terminal 22 and the PoC server 98. In particular, core server 92 receives requests for specified group sessions from inviting mobile terminals 22 and forwards these requests, along with a selected list of potential group members, to the PoC server 98.

Group server 94, also known as the Group and List Management Server (GLMS), is responsible for managing the various PTT groups, contact lists, and access lists associated with each mobile terminal 22. Each PTT group comprises a collection of PoC user identities defined by a potential inviting mobile terminal 22, as discussed above. A contact list is a kind of address book accessible by mobile terminals 22 for establishing ad hoc group sessions. Contact list management, as performed by group server 94, includes operations that allow a mobile terminal 22 to store and retrieve the contact list(s) stored in group server 94.

The access lists in group server 94 define access restrictions for each mobile terminal 22. A mobile terminal 22 uses the access lists maintained by group server 94 to provide or deny access to other mobile terminals 22 for future group sessions. In general, an access list may include a block list and a grant list. The block list contains a list of mobile terminals 22 that are blocked from contacting a mobile terminal 22 using PTT communications or are otherwise blocked from participating in a group session with the mobile terminal 22. The grant list contains a list of mobile terminals 22 that are allowed to contact a mobile terminal 22 using PTT communications or are otherwise allowed to participate in a group session with the mobile terminal 22. For example, user J may decide to permanently block user K and user L from participating in any group sessions with user J. To implement this decision, the user updates their block list to include user J and user K. The updated list is then stored in group server 94. In some embodiments, the group server 94 may provide these lists directly to the PoC server 98.

In some PTT controllers 90, the group server 94 and the core server 92 exchange information directly. However, as shown in FIG. 4, the group server 94 and the core server 92 may also exchange information via the presence server 96. The presence server 96 manages presence and location information corresponding to mobile terminals 22 with PTT capabilities. In other words, the presence server 96 monitors the availability and location of all mobile terminals 22 with PTT capabilities. In some embodiments, the presence server 96 may also include memory circuits 97 for storing presence and location information related to mobile terminals 22 with PTT capabilities. In addition, the presence server 96 may keep dynamic lists of mobile terminals 22 currently located in selected areas. It will be appreciated by those skilled in the art that the presence and location information may be obtained by the PTT controller 90 according to any means known in the art. The methods used to obtain the presence and location information are not relevant to the present invention, and therefore, are not discussed further herein.

In addition to managing the presence and location information, presence server 96 may also define a local area 20 associated with each inviting mobile terminal 22. In an exemplary embodiment, the presence server may use information provided by a GPS, Cell Id, or other position locating system to locate the inviting mobile terminal 22 and define a local area 20 surrounding the inviting mobile terminal 22, as described above. Alternatively, the presence server 96 may store a location of the inviting mobile terminal 22 and/or a local area 20 defined by the inviting mobile terminal 22 in memory 97.

Once the local area 20 is defined, the presence server 96 may identify mobile terminals 22 located within the local area 20 and may group them into a local ad hoc group 24 (FIG. 1). It will be appreciated by those skilled in the art that the presence server 96 may use any known technique for identifying mobile terminals 22 in a predefined local area 20 of an inviting mobile terminal 22. In an exemplary embodiment, the presence server may use information provided by a GPS or other position locating system to identify one or more mobile terminals 22 within local area 20. The presence server 96 may, alternatively, obtain a list of mobile terminals 22 in the same cell and/or adjacent cells from the HLR 82 and/or LR 80.

For each mobile terminal 22 located in local area 20 in FIG. 1, the presence server 96 may define a local ad hoc group 24 comprising the inviting mobile terminal 22 and the remaining mobile terminals 22 located within the local area 20. Such groups may be defined on request, e.g. in response to a request to establish a local ad hoc group session, or may be predefined and stored in memory 97. When the groups are predefined, the presence server 96 may dynamically update the predefined groups stored in memory 97 on a regular basis to account for any mobile terminals 22 that enter and/or leave the local area 20 over time. In any event, the local ad hoc groups 24 defined by the presence server 96 identify mobile terminals 22 appropriate for a local ad hoc group session with an inviting mobile terminal 22.

Once the group of mobile terminals 22 has been identified, the core server 92 forwards the appropriate identification information for the group of mobile terminals 22, along with a group session establishment request, to the PoC server 98. Alternatively, the POC server may have a direct interface to the presence server and may negotiate the identification and reception of the group of terminals 22 over that interface. In response, the PoC server 98 sends an invite message to each identified mobile terminal 22. The PoC server 98 then establishes and manages the PTT connection between the inviting mobile terminal 22 and one or more mobile terminals 22 that accept the invitation.

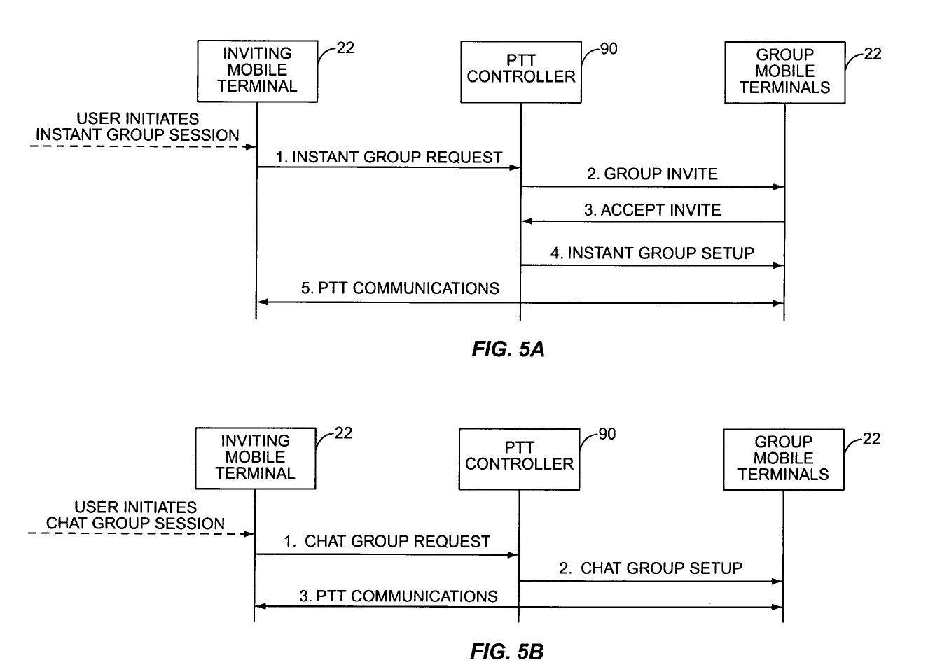

Turning now to FIGS. 5A and 5B, an exemplary call-flow for a conventional PTT group session will be discussed. To establish an instant group session, as shown in FIG. 5A, an inviting mobile terminal 22 sends an instant group request to the PTT controller 90 (arrow 1) for an instant group session with a predefined group of mobile terminals 22. PTT controller 90 then sends an invite message to one or more mobile terminals 22 listed in the predefined group (arrow 2). The mobile terminals 22 that accept the invitation respond back to the PTT controller 90 (arrow 3). In response, the PTT controller 90 establishes the instant group session (arrow 4) so that the inviting mobile terminal 22 and the accepting mobile terminals 22 may commence communications (arrow 5) according to standard PTT communication protocols.

To establish a chat group session, as shown in FIG. 5B, the inviting mobile terminal 22 sends a chat group request to the PTT controller 90 (arrow 1) for a chat group session. The PTT controller 90 then establishes the chat group session (arrow 2) so that the inviting mobile terminal 22 and any mobile terminals 22 that join the chat may commence communications (arrow 3) according to standard PTT communication protocols.

While not shown in FIGS. 5A and 5B, those skilled in the art will appreciate that group server 94 in PTT controller 90 may restrict the predetermined or ad hoc groups by filtering the groups according to stored access lists, as discussed above. Group server 94 may also restrict the participation of one or more mobile terminals 22 trying to join a chat group session based on the stored access lists.

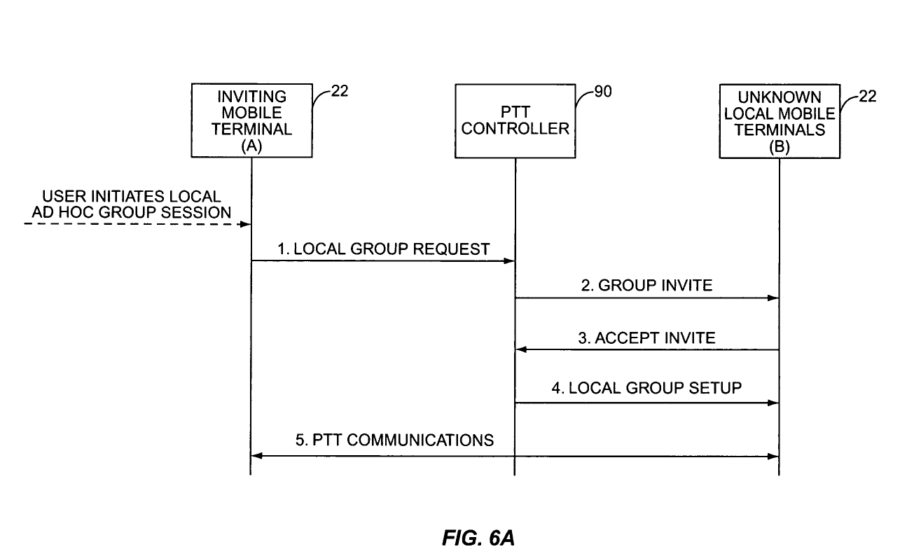

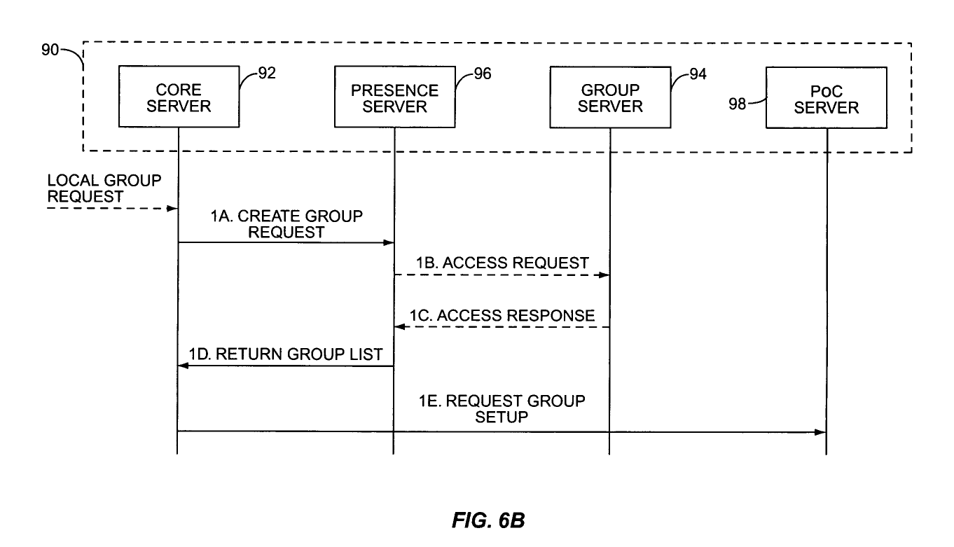

Turning now to FIGS. 6A and 6B, an exemplary call flow for establishing a local ad hoc group session in the wireless network 5 shown in FIG. 1 will be discussed. FIG. 6A illustrates a top-level call-flow chart. As shown in FIG. 6A, an inviting mobile terminal 22, indicated by letter A in FIG. 1, initiates a local ad hoc group session by sending a local group request to the PTT controller 90 (arrow 1). Such a request may, for example, utilize the same SIP signaling protocols used by an inviting mobile terminal 22 to request a conventional group session. In some embodiments, the request may also indicate a topic of interest, such as assistance, traffic, weather, sports, etc.

The PTT controller 90 then processes the request and identifies local mobile terminals 22, indicated by letter B in FIG. 1, that are located in a local area 20 of the inviting mobile terminal 22-A and that satisfy any topic of interest requirements identified by the user, if one is specified. Such mobile terminals 22-B may or may not be known to the inviting mobile terminal 22-A in advance. After processing the request, PTT controller 90 sends an invite message to each local mobile terminal 22-B identified by PTT controller 90 (arrow 2). The mobile terminals 22-B that accept the invitation respond to the PTT controller 90 with an accept invite message (arrow 3). In response, the PTT controller 90 establishes the local ad hoc group session (arrow 4) so that the inviting mobile terminal 22-A and the accepting mobile terminals 22-B may commence communications (arrow 5) according to standard PTT communication protocols.

FIG. 6B provides further details regarding the processing of the local ad hoc group session request in the PTT controller 90. After receiving the local group request from inviting mobile terminal 22-A (arrow 1, FIG. 6A), the core server 92 sends a create group request to the presence server 96 to identify local mobile terminals 22-B within the local area 20 of the inviting mobile terminal 22-A (arrow 1A). The list may include mobile terminals 22 unknown to the inviting mobile terminal 22-A, and may be created upon request or may be retrieved from memory 97 as discussed above.

The presence server 96 may then optionally send an access request to the group server 94 for an evaluation of the local mobile terminals 22-B identified by the presence server 96 (arrow 1B). The group server 94 then provides an access response that identifies all mobile terminals in the list of local mobile terminals 22-B that satisfy one or more group server requirements, such as media type restrictions, access control restrictions, topic of interest restrictions identified by the user (arrow 1C). Further, because the access restrictions may include a new access type related to local ad hoc group sessions, the group server 94 may also provide an access response that identifies all mobile terminals in the list of local mobile terminals 22-B that satisfy the local ad hoc group session access requirements. The presence server 96 returns a list of local mobile terminals 22-B to the core server 92. The list includes mobile terminals 22-B in the local area 20 of the inviting mobile terminal 22-A that satisfy the requirements of the group server 94 (arrow 1D). Core server 92 then sends the resulting group list to the PoC server 98 with a group setup request to establish a local ad hoc group session (arrow 1E).

The present application provides a method and apparatus for establishing a local ad hoc group session between an inviting mobile terminal 22-A and one or more local mobile terminals 22-B, which may be unknown to the inviting mobile terminal 22-A, in a local area 20 of the inviting mobile terminal 22-A. Private citizens as well as local authorities may disseminate information and/or provide assistance using these local ad hoc group sessions. For example, an end user who is lost in an unfamiliar city may use a local ad hoc group session to request directions from nearby end users who may be more familiar with the region. In addition, local authorities may notify any end users proximate an accident or a new construction site of lane closings or slow traffic. Local ad hoc group sessions may also enable end users in a given local area 20 with a common interest, such as sports, politics, etc., to converse on their favorite topics. As such, the local ad hoc group sessions described herein provide useful and valuable options for cellular customers interested in additional PTT capabilities.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A push-to-talk controller in a wireless network for establishing a local ad hoc group session between an inviting mobile terminal and local mobile terminals, the push-to-talk controller comprising:
a presence server for identifying local mobile terminals within a local area of the inviting mobile terminal; and
a push-to-talk server for establishing the local ad hoc group session between the inviting mobile terminal and one or more local mobile terminals responsive to a request from the inviting mobile terminal.

2. The push-to-talk controller of claim 1 wherein the push-to-talk server sends an invite message to local mobile terminals identified by the presence server and establishes the local ad hoc group session between the inviting mobile terminal and one or more local mobile terminals that respond to the invite message.

3. The push-to-talk controller of claim 1 further comprising a core server that receives the request from the inviting mobile terminal and forwards a list of the local mobile terminals identified by the presence server to the push-to-talk server.

4. The push-to-talk controller of claim 1 further comprising a group server to filter a list of local mobile terminals identified by the presence server based on at least one of a media type restriction and an access control restriction to identify preferred local mobile terminals.

5. The push-to-talk controller of claim 4 wherein the push-to-talk server sends an invite message to each of the preferred local mobile terminals and establishes the local ad hoc group session between the inviting mobile terminal and one or more of the preferred local mobile terminals that respond to the invite message.

6. The push-to-talk controller of claim 4 wherein the group server further filters the local mobile terminals based on a subject of interest identified by the inviting mobile terminal.

7. The push-to-talk controller of claim 1 wherein the presence server determines a current location of the inviting mobile terminal.

8. The push-to-talk controller of claim 7 wherein the presence server defines the local area based on the current location of the inviting mobile terminal.

9. The push-to-talk controller of claim 1 wherein the presence server receives a defined local area from the inviting mobile.

10. The push-to-talk controller of claim 1 wherein the presence server identifies local mobile terminals within the local area of the inviting mobile terminal by identifying local mobile terminals in at least a portion of the same cell as the inviting mobile terminal.

11. The push-to-talk controller of claim 1 wherein the presence server identifies local mobile terminals within the local area of the inviting mobile terminal by identifying local mobile terminals within a defined distance of the inviting mobile terminal.

12. The push-to-talk controller of claim 1 further comprising a memory for dynamically storing groups and dynamically storing updated lists of local mobile terminals within the local area of the inviting mobile terminal.

13. A method of establishing a local ad hoc group session in a wireless network between an inviting mobile terminal and local mobile terminals, the method comprising:
receiving a request to initiate the local ad hoc group session from the inviting mobile terminal;
identifying local mobile terminals within a local area of the inviting mobile terminal; and
establishing the local ad hoc group session between the inviting mobile terminal and one or more of the local mobile terminals.

14. The method of claim 13 wherein establishing the local ad hoc group session comprises:
sending an invite message to local mobile terminals within the local area of the inviting mobile terminal; and
establishing the local ad hoc group session between the inviting mobile terminal and one or more of the local mobile terminals that respond to the invite message.

15. The method of claim 13 further comprising identifying preferred local mobile terminals by filtering a list of local mobile terminals within the local area of the inviting mobile terminal based on at least one of a media type restriction and an access control restriction.

16. The method of claim 15 wherein establishing the local ad hoc group session comprises:
sending an invite message to one or more preferred local mobile terminals; and
establishing the local ad hoc group session between the inviting mobile terminal and preferred local mobile terminals that respond to the invite message.

17. The method of claim 15 wherein identifying preferred local mobile terminals further comprises filtering the list of local mobile terminals within the local area of the inviting mobile terminal based on a subject of interest identified by the inviting mobile terminal.

18. The method of claim 13 wherein identifying local mobile terminals within a local area of the inviting mobile terminal comprises identifying local mobile terminals within at least a portion of a base station cell containing the inviting mobile terminal.

19. The method of claim 13 wherein identifying local mobile terminals within a local area of the inviting mobile terminal comprises identifying local mobile terminals within a defined distance of the inviting mobile terminal.

20. The method of claim 13 further comprising storing and dynamically updating groups of local mobile terminals within one or more local areas of the inviting mobile terminal.

21. A mobile terminal in a wireless network, the mobile terminal comprising:
a transceiver for transmitting and receiving signals in the wireless network; and
a push-to-talk processor for initiating a local ad hoc group session between the inviting mobile terminal and one or more local mobile terminals within a local area of the inviting mobile terminal responsive to a user input.

22. The mobile terminal of claim 21 further comprising a display and a menu system displayed on the display, wherein a user requests the local ad hoc group session by selecting a local ad hoc group option from a menu.

23. The mobile terminal of claim 22 wherein the menu system comprises a sub-menu associated with the local ad hoc group option for selecting a subject of interest.

24. The mobile terminal of claim 22 wherein the menu system comprises a sub-menu associated with the local ad hoc group option for defining the local area.

25. The mobile terminal of claim 21 further comprising a multi-directional control button located on an outer housing of the mobile terminal for requesting the local ad hoc group session by the user.

26. The mobile terminal of claim 21 further comprising a location processor for determining a current location of the inviting mobile terminal.

27. The mobile terminal of claim 26 wherein the location processor defines the local area based on the current location of the inviting mobile terminal.

28. A method of initiating a local ad hoc group session at an inviting mobile terminal comprising:
initiating a local ad hoc group session by a user of the inviting mobile terminal; and
sending a request to a network push-to-talk controller to establish the local ad hoc group session between the inviting mobile terminal and one or more local mobile terminals within a local area of the inviting mobile terminal responsive to the user initiation.

29. The method of claim 28 wherein initiating the local ad hoc group session by the user of the inviting mobile terminal comprises selecting a local ad hoc group option from a menu associated with the inviting mobile terminal.

30. The method of claim 28 wherein initiating the local ad hoc group session by the user of the inviting mobile terminal comprises activating a multi-directional control button located on an outer housing of the inviting mobile terminal.

31. The method of claim 28 wherein initiating the local ad hoc group session by the user of the inviting mobile terminal comprises providing a push-to-talk voice command to the inviting mobile terminal.

32. The method of claim 28 further comprising selecting a subject of interest and initiating the local ad hoc group session between the inviting mobile terminal and one or more local mobile terminals based on the subject of interest.

33. The method of claim 28 further comprising defining the local area of the inviting mobile terminal.

34. The method of claim 33 wherein defining the local area of the inviting mobile terminal comprises defining the local area as an area within at least a portion of a base station cell containing the inviting mobile terminal.

35. The method of claim 33 wherein defining the local area of the inviting mobile terminal comprises defining the local area as a defined distance from the inviting mobile terminal.

36. The method of claim 33 wherein defining the local area of the inviting mobile terminal comprises defining the local area based on user input.
